(19) United States
(12) Patent Application Publication
(10) Pub. No.: US 2004/0178964 A1
(43) Pub. Date: Sep. 16, 2004

(54) Two-dimensional antenna array

(75) Inventors: Max Gottl, Frasdorf (DE); Jurgen Rumold, Bad Endorf (DE)

Correspondence Address: NIXON & VANDERHYE, PC, 1100 N GLEBE ROAD, 8TH FLOOR, ARLINGTON, VA, 22201-4714, US

(73) Assignee: Kathrein-Werke KG, Rosenheim (DE)

(21) Appl. No.: 10/625,850

(22) Filed: Jul. 24, 2003

Related U.S. Application Data
(63) Continuation-in-part of application No. 10/408,780, filed on Apr. 8, 2003.

(30) Foreign Application Priority Data
Dec. 5, 2002 (DE) 102 56 960.6-35
Jul. 17, 2003 (DE) 103 32 619.7

(51) Int. Cl. H01Q 21/26; H01Q 21/00

(52) U.S. Cl. 343/797; 343/893; 343/700 MS

(57) ABSTRACT

An improved antenna array is characterized by the following features:

there are at least two vertically running gaps (5; 5a, 5b, 5c, 5d),

there are overall at least two and preferably at least three radiators or radiator groups (9; 109a, 109b, 109c, 109d) offset to one another in the vertical direction in one gap (5; 5a, 5b, 5c, 5d) and preferably in all gaps (5; 5a, 5b, 5c, 5d),

in at least one gap (5; 5a, 5b, 5c, 5d) the arrangement is such that the radiators or radiator groups (9) in this at least one gap (5; 5a, 5b, 5c, 5d) except for at least one radiator or at least one radiator group (109a, 109b, 109c, 109d) are jointly supplied, and

this at least one radiator or at least one radiator group (109a, 109b, 109c, 109d) is supplied jointly with the radiators or radiator groups (9) of an adjacent gap (5; 5a, 5b, 5c, 5d).

The invention relates to a two-dimensional antenna array according to the preamble of claim 1 as claimed in the main patent no. 102 56 960.6

As claimed in the main patent, proceeding from the generic prior art for example as claimed in U.S. Pat. No. 6,351,243 an improved antenna array is suggested with which certain half-value widths are produced for the radiators or radiator groups in the individual gaps according to requirements.

As claimed in the main patent, therefore a two-dimensional antenna array with the following features has been proposed:

there are at least two vertically running gaps,

there are overall at least two and preferably at least three radiators or radiator groups offset to one another in the vertical direction in one gap and preferably in all gaps,

in at least one gap the arrangement is such that the radiators or radiator groups in this at least one gap except for at least one radiator or at least one radiator group are jointly supplied, and

this at least one radiator or at least one radiator group is supplied jointly with the radiators or radiator groups of an adjacent gap.

As claimed in the main patent, the most varied embodiments and reversal possibilities for the aforementioned general principle are reproduced for this purpose.

Within the framework of this application other embodiments for this general inventive idea will be explained.

In particular:

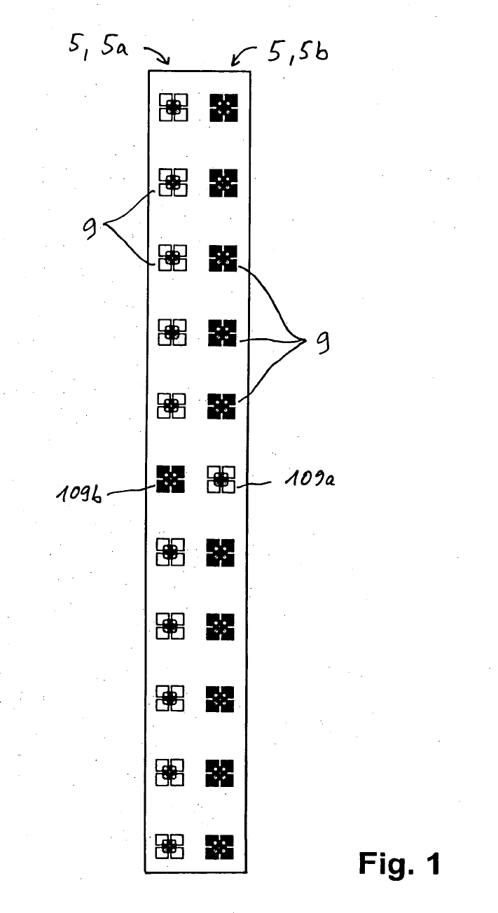

FIG. 1 shows another embodiment for a dual-gap antenna array;

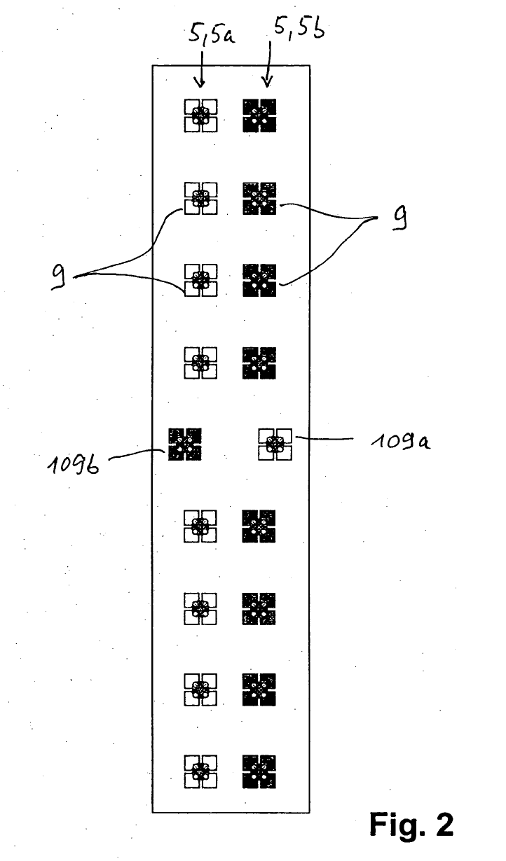

FIG. 2 shows an embodiment which has been slightly modified relative to FIG. 1; and

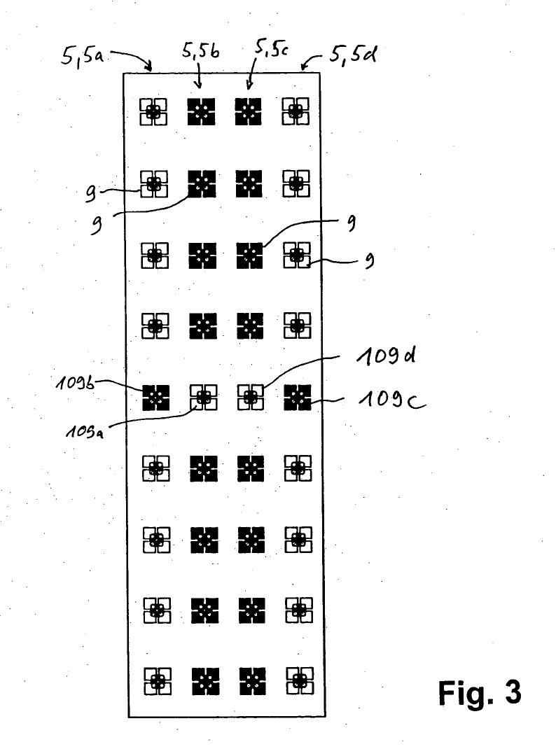

FIG. 3 shows one embodiment for a quadruple-gap antenna array.

Due to the overall structure of the antenna arrays which are explained below in addition, reference is made to the disclosure contents of the basic German application 102 56 960.6 in its full scope and to the contents of this application.

In the embodiment as shown in FIG. 1 there is an antenna array with two gaps 5, i.e. one gap 5a and one gap 5b in which there are a plurality of dual-polarized radiators 9 at a regular vertical distance over one another.

The radiators 9 which are shown as light in FIG. 1 in the left gap 5a are jointly supplied. In this embodiment it is apparent that for the radiators in the left gap 5a-as in this embodiment in the middle, but this is not absolutely necessary—one radiator 109b is shown which is drawn dark. In a conventional antenna array according to the prior art this radiator 109b which is shown dark and which is reproduced in the left gap 5a in the middle would likewise be supplied with the other radiators in this gap 5a. Here the vertical distance between all the illustrated radiators 9 of the left gap 5a would be entirely or mostly at the same grid spacing vertically on top of one another. In contrast to the prior art, it is however provided here that the radiator which is provided in the middle in addition to the radiators 9 which are shown as light there and which are jointly supplied in the left gap 5a is not located in the left gap, but offset to it in the right gap 5b where it is identified with reference number 109a and is shown sitting in the right gap in the middle. All the radiator elements which are sitting in the left gap 5a and which are shown as light are now jointly supplied with the radiator 109a which is located in the right gap 5b and which is likewise shown as light. The vertical grid sequence, i.e. the vertical distance, generally speaking therefore the vertical component of the three-dimensional distance between two adjacent jointly supplied radiators 9, 109 at a time, has therefore remained the same. This is because, proceeding from a conventional antenna array according to the prior art, only one radiator 109 has been taken and positioned in an adjacent gap 5b. Likewise all these radiators which are shown as light in FIG. 1 are jointly supplied.

The same applies to the radiators 9 which are shown in the embodiment illustrated in FIG. 1 for the right gap 5b and are drawn basically dark there. Ultimately the embodiment as shown in FIG. 1 arises solely in that proceeding from a conventional radiator element the radiators 109a and 109b which are positioned in a vertical line are not located in the gap in which they are jointly supplied with tile remaining radiators 109, but that these two radiators 109a, 109b located on the same vertical line are interchanged in their position so that the radiator 109a which is jointly supplied with the radiators 9 which are located in the gap 5a now sits in another gap which is offset to it, generally in the adjacent gap 5b and that vice versa the radiator 109b which is located with the radiators 9 which are jointly supplied in the right gap 5b is now positioned in the left gap. Likewise the embodiment shown in FIG. 1 could also be interpreted such that at least one pair of radiators 109a, 109b is fixed only on a common vertical line and they are not jointly supplied with the radiators located in the same gap, but are jointly supplied alternately with the radiators in the adjacent group.

In contrast to the embodiment shown in FIG. 1, of course one other pair of radiators at a time on other vertical lines could also be taken, in which radiators the pertinent radiator is not jointly supplied with the other radiators located in the same gap, but with the radiators which are located in an adjacent gap.

In contrast to the embodiment shown in FIG. 1, of course the number of the radiators or radiator groups provided overall in each gap can be more or less than in the embodiment shown. Likewise the number of radiators in the individual gaps can differ from one another. Even the type of radiator element used can be chosen to be different, for example in the form of a dipole cross, dipole square, a so-called vector dipole as is explained using the embodiment shown in FIG. 1, etc. This radiators 109a and 109b sitting in another gap in FIG. 1 could also be located horizontally offset to the outside so that the total width of the antenna array would become twice as wide in this way. But this would require only unneeded installation space, for which reason the much more efficient, space-saving approach is the one as is explained using FIG. 1. This is because the lateral offset of the radiators 109a and 109b can be undertaken there without needing additional installation space.

With the antenna array as shown in FIG. 1 (but basically also likewise with respect to FIG. 2 and FIG. 3 which are still to be explained) it is possible to use the jointly supplied radiators as an antenna which is operated separately from the jointly supplied radiators which are located mostly in another gap. Therefore this is also possible since conventionally the jointly supplied radiators are sufficiently decoupled from the other radiators although they can ordinarily be used or operated in the same frequency band or frequency range. In the transmit mode however usually only one antenna is used, i.e. for example the radiators 9 which are in the left gap 5a in FIG. 1 and shown as light there together with the radiators 109a which are located in the right gap, positioned in the middle and shown likewise as light there. This at least one additional radiator unit 109a changes the beam width in the horizontal direction and the beam width can thus preferably be reduced. Without this at least one additional radiator unit 9a is located in the other gap, otherwise the half-value width of one such gap-shaped antenna structure would necessarily be between 80 to 100°, i.e. especially around 90°, and this half-value width could essentially not be changed or reduced. Since the antenna arrays under consideration could preferably also be used as so-called smart antennas in which the radiators located in several gaps are used for beam shaping, in order to be able to adjust the major lobe of the antenna array in different azimuth directions, it is especially necessary for the horizontal distance of the centers of the radiators, therefore the horizontal distance between the vertical lines on which the radiators 9 are located in two adjacent gaps, to be roughly λ/2 (the deviation should preferably be less than ±20% or less than ±10% or even less than ±5%), this makes it difficult to reduce the radiation spectrum of an individual antenna to distinctly less than 90° half-value width. This is furthermore possible by the approach as claimed in the invention with the arrangement of one or more radiators or radiator groups in an adjacent gap. In particular, in reception the antenna array can be operated likewise separately again with respect to the radiation of individual gaps or can be interconnected in several gaps.

FIG. 2 differs from FIG. 1 on the one hand only in that in one gap there are not eleven radiators on top of one another, but only nine. This is relatively unimportant however in that the number of radiators located on top of one another can differ arbitrarily anyway in the individual gaps.

Using FIG. 2 it has simply been shown that the horizontal offset of the two middle radiators 109a and 109b which are each supplied alternately with the radiators 9 in the gap which is the other one at the time, is greater than the horizontal distance of the remaining radiators which are located on a vertical line in the adjacent gaps. In this way the horizontal beam spectrum can be influenced and changed again. In the embodiment shown the distance between the centers of the radiators located in the left and right gaps is roughly λ/2 or is in this range. I.e., that the distance between the radiators of the left and right gap can be for example less than λ/2±20% or preferably less than λ/2±10%, at this point the distance between the centers of the two radiators 109a, 109b which are offset to the outside and which are located in the middle is for example in the range between λ/2 and λ. But here the distance can also be chosen to be distinctly greater in order to implement different beam shaping widths.

FIG. 3 shows an example for a quadruple-gap antenna array with gaps 5a, 5b, 5c, and 5d. In each gap there is a total of 9 radiators in this embodiment.

Usually all radiators in one gap are supplied jointly. In this embodiment on the middle vertical line however reversal of the feed in pairs has been undertaken such that the radiators 9 which are jointly supplied in the left gap 5a are not jointly supplied with the middle radiator 109b which is located in the left gap 5a, but with the radiator 109a which is provided on the same vertical line in the second gap 5b.

Conversely, the radiators 9 which are located in the second gap and which are shown dark are supplied jointly, but not with the radiator which is located in the middle. Here joint feed takes place with the radiator 109b which is located in the first gap 5a.

Likewise feed is undertaken reversed in the third and fourth gap 5c, 5d. Nor here are the radiators 9 shown as light in the gap 5d jointly supplied with the radiator 109c which is located in the middle in the same gap, but with the radiator 109d which is located in the middle in the third gap 5c. The radiators which are shown dark and which are located in the third gap 5c are then jointly supplied with the radiator unit 109c which is located in the middle of the antenna array in the gap 5d.

In this embodiment in turn other pairs of radiators on other vertical lines can likewise be supplied reversed. Otherwise all the radiators shown as light in FIG. 3 can also be jointly supplied and for example all the radiators shown dark can be jointly supplied.

In the embodiment as shown in FIG. 3 the distance between two horizontally adjacent radiators which are located in two different gaps is preferably λ/2. That is, in general the distance between the horizontally adjacent radiators is λ/2±less than 20% or ±less than 10% difference therefrom.

Beam shaping within one gap can be preset differently with the simplest means by all these measures. This is because, depending on whether in one gap only some of the radiators provided there are jointly supplied and whether and if and how many other jointly supplied radiators are located in another gap, a horizontal pattern of differing width is achieved with respect to the gap of one such antenna array.

1. Two-dimensional antenna array with the following features:
there are at least two vertically running gaps (5; 5a, 5b, 5c, 5d),
there are overall at least two and preferably at least three radiators or radiator groups (9; 109a, 109b, 109c, 109d) offset to one another in the vertical direction in one gap (5; 5a, 5b, 5c, 5d) and preferably in all gaps (5; 5a, 5b, 5c, 5d),
in at least one gap (5; 5a, 5b, 5c, 5d) the arrangement is such that the radiators or radiator groups (9) in this at least one gap (5; 5a, 5b, 5c, 5d) except for at least one radiator or at least one radiator group (109a, 109b, 109c, 109d) are jointly supplied, and
this at least one radiator or at least one radiator group (109a, 109b, 109c, 109d) is supplied jointly with the radiators or radiator groups (9) of an adjacent gap (5; 5a, 5b, 5c, 5d).

2. Antenna array as claimed in claim 1, wherein the respectively jointly supplied radiators or radiator groups (9) are arranged such that even at a given horizontal offset the vertical distance is the same.

3. Antenna array as claimed in claim 1 or 2, wherein the respectively jointly supplied radiators or radiator groups (9; 109a, 109b, 109c, 109d) are arranged offset to one another in the vertical direction such that the vertical distance between two radiators or radiator groups (9; 109a, 109b, 109c, 109d) which are vertically offset to one another or the vertical distance of the radiators or radiator groups (9; 109a, 109b, 109c, 109d) which are located horizontally at different heights is the same or similar for most of the radiators or radiator groups (9; 109a, 109b, 109c, 109d).

4. Antenna array as claimed in claim 3, wherein the respectively jointly supplied radiators or radiator groups (9; 109a, 109b, 109c, 109d) are arranged offset to one another in the vertical direction such that the vertical distance between two radiators or radiator groups (9; 109a, 109b, 109c, 109d) which are vertically offset to one another or the vertical distance of the radiators or radiator groups (9; 109a, 109b, 109c, 109d) located horizontally at different heights is the same or similar for all of the radiators or radiator groups (9; 109a, 109b, 109c, 109d).

5. Antenna array as claimed in one of claims 1 to 4, wherein the radiators or radiator groups (9; 109a, 109b, 109c, 109d) are located in pairs on a common vertical line in at least two gaps (5; 5a; 5b).

6. Antenna array as claimed in one of claims 1 to 5, wherein the respectively jointly supplied radiators or radiator groups (9; 109a, 109b, 109c, 109d) are located at a regular vertical distance on top of one another and at least one radiator or at least one radiator group (109a, 109b, 109c, 109d) is located simply with a horizontal offset to the other jointly supplied radiators or radiator groups (9) in an adjacent gap (5; 5a, 5b, 5c, 5d).

7. Antenna array as claimed in one of claims 1 to 6, wherein in at least two gaps (5; 5a, 5b, 5c, 5d) the radiators or radiator groups (9; 109a, 109b, 109c, 109d) are located at a regular vertical distance to one another and in the same vertical position in pairs, in at least two gaps (5; 5a, 5b, 5c, 5d) there being at least one pair of two radiators or two radiator groups (109a, 109b, 109c, 109d) such that the radiators or radiator groups (9; 109a, 109b, 109c, 109d) which are jointly supplied and located in one gap (5; 5a, 5b, 5c, 5d) are jointly supplied with at least one radiator or at least one radiator group (109a, 109b, 109c, 109d) of the adjacent gap (5; 5a, 5b, 5c, 5d).
